(19) United States
(12) Patent Application Publication
(10) Pub. No.: US 2015/0039699 A1
(43) Pub. Date: Feb. 5, 2015

(54) System and Method for Displaying and Notifying Collective Events for a Group

(71) Applicant: Wayne Wei Jiang, Sugarland, TX (US)

(72) Inventor: Wayne Wei Jiang, Sugarland, TX (US)

(21) Appl. No.: 13/959,453

(22) Filed: Aug. 5, 2013

(51) Int. Cl. H04L 29/06

(52) U.S. Cl. CPC H04L 65/403
USPC 709/206

(57) ABSTRACT

A system and method for displaying collective events for a group is disclosed herein. One method comprises receiving, by a reminder device, a plurality of events from a server. Each of the events can be from a user within a group, and the events can be addressed to the reminder device. The method can also comprise the step of displaying the events in a blog on a screen on the reminder device. The reminder device can be displayable in a location accessible by the group.

### BACKGROUND

This disclosure relates to an improved system and method for displaying and notifying collective events for a group

Methods for reminding and notifying individual or family members about special occasions, to-do's, and other important activities, have evolved over the years. A popular method of leaving sticky notes or marking calendars is one of the oldest practices that are still being used today. This method can be effective however it can also be tedious most especially for events and activities that are usually repeated such as birthdays, anniversaries, or grocery shopping. Moreover, such method can require an additional task of organizing the scheduled events at a particular order.

Thus, reminder applications and devices have been developed to be used for this purpose. The method employed by reminder devices and application are usually focused on one individual or the user. As such, only the user would be reminded of a particular task or event. Therefore, having a single device that can remotely receive reminders from a specific group of individual can be an effective reminder tool. As such, any member of a group can send a notification to the device and other group members or individuals who have an access to the device can perform the task or to-do accordingly. Moreover, most reminder applications or devices usually remind user through text-message form. A reminder can be more effective when other medium such as photo, video, and audio file can be used to notify a group or individuals of a certain event or activities.

Furthermore, most reminder devices only functions as a notification tool. Therefore, having a reminder device that can collect and store important memories, thoughts, and events can be a great addition to the function of a reminder device. As such, collection of texts, images, videos, and audio files that can capture important memories or events, can be stored and be revived at any time. As such it would be useful to have an improved system and method for displaying and notifying collective events for a group.

### SUMMARY

A system and method for displaying collective events for a group is disclosed herein. One method comprises receiving, by a reminder device, a plurality of events from a server. Each of the events can be from a user within a group, and the events can be addressed to the reminder device. The method can also comprise the step of displaying the events in a blog on a screen on the reminder device. The reminder device can be displayable in a location accessible by the group.

A reminder device can comprise a screen, a processor, and a memory. The memory can comprise a memory that stores an application. The application can be programmed to receive a plurality of events from a server, each of the events from a user within a group. The events can be addressed to the reminder device. The application can also be programmed to display the events in a blog on the screen on the reminder device. The reminder device can be displayable in a location accessible by the group.

### BRIEF DESCRIPTION OF THE DRAWINGS

FIG. 1 illustrates a communication network system.

FIG. 2A illustrates an embodiment of a reminder device.

FIG. 2B illustrates an internal hardware of a reminder device.

FIG. 2C illustrates a reminder device memory.

FIG. 3 illustrates a schematic diagram of a server.

FIG. 4A illustrates a server data store.

FIG. 4B illustrates a reminder device profile.

FIG. 4C illustrates an event.

FIG. 5 illustrates a screen of an electronic device displaying create a reminder page.

FIG. 6 illustrates a screen of a reminder device displaying a created event, as an event notification page.

FIG. 7 illustrates a screen of a reminder device displaying a main page.

FIG. 8 illustrates an exemplary method for displaying an event on a reminder device.

FIG. 9 illustrates a second exemplary method for displaying an event on a reminder device.

### DETAILED DESCRIPTION

Described herein is an improved system and method for displaying and notifying collective events for a group. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

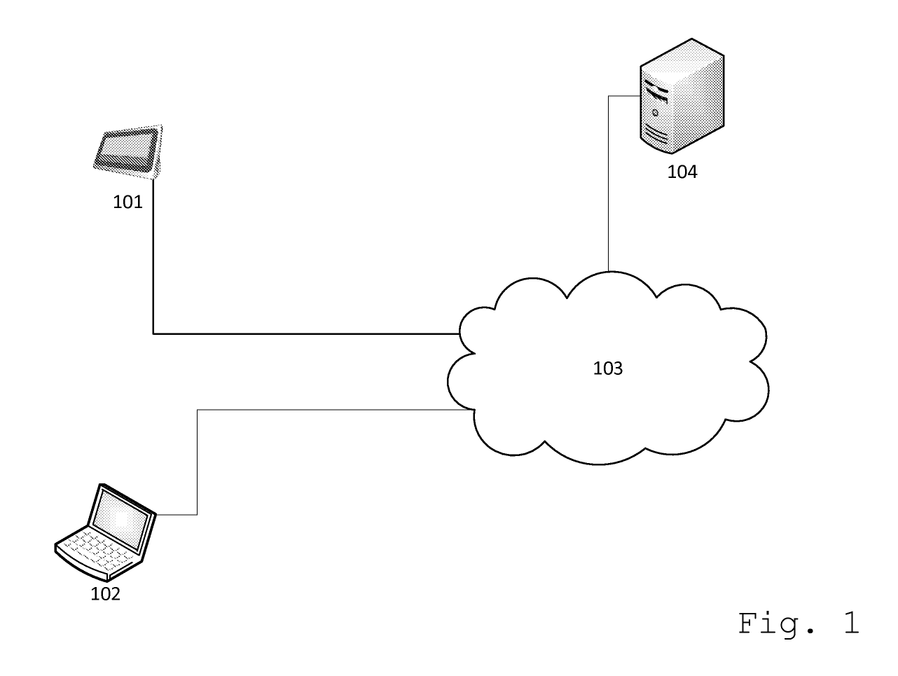

FIG. 1 illustrates a communication network comprising one or more reminder device 101 and/or electronic device 102, one or more (first) server 104 and/or (second) server 105 connected via a network 103. Reminder device 101 is electronic equipment programmed essentially for the function of sending, receiving and collecting notification from a user or group of users in a public environment. Moreover, reminder device 101 can be used to create and store collection of events. Reminder device 101 can also receive, and store data information from electronic device 102 through network 103. As such, one or more electronic device 102 can send data information to reminder device 101. Electronic device 102 can include, but is not limited to, a mobile phone, a laptop, a personal digital assistant (PDA), and/or a tablet. In one embodiment, reminder device 101 can use mobile phone tracking technology that uses radio signals between several radio towers, and/or Global Positioning System (GPS) to determine current time and location of the reminder device 101 or the electronic device 102.

Server 104 can provide and perform computational tasks across network 103. Server 104 can send and receive data to reminder device 101 and electronic device 102. Network 103 can be a wide area network (WAN), or a combination of local area network (LAN), and/or piconets. Network 103 can be hard-wired, wireless, or a combination of both. A LAN can be a network within a single business while WAN can be an Internet.

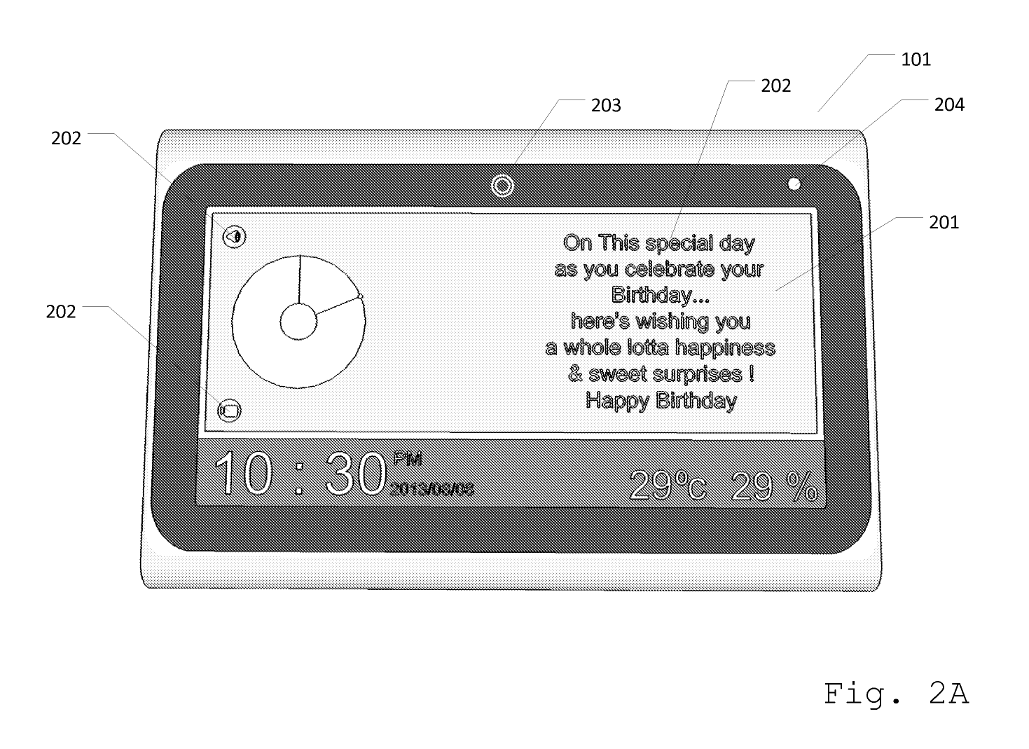

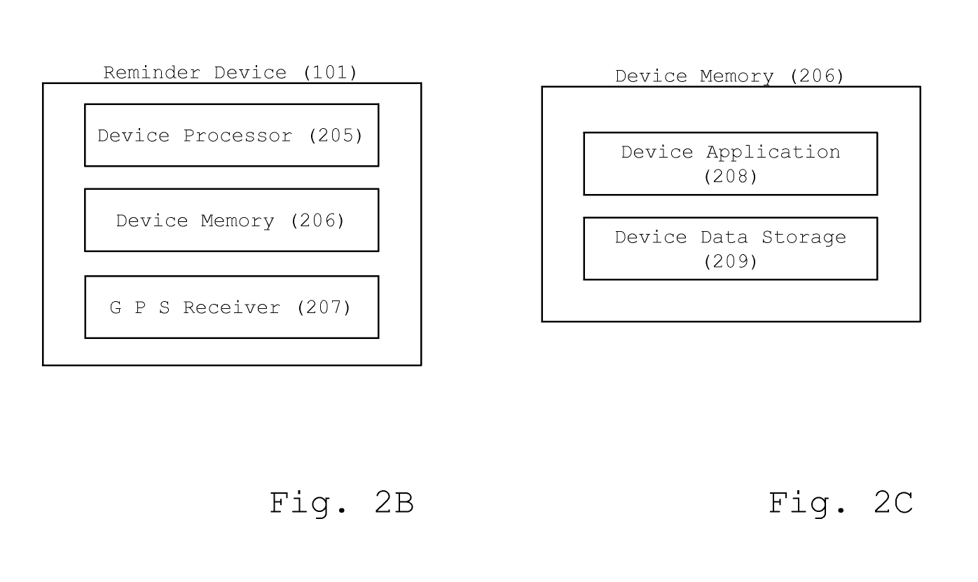

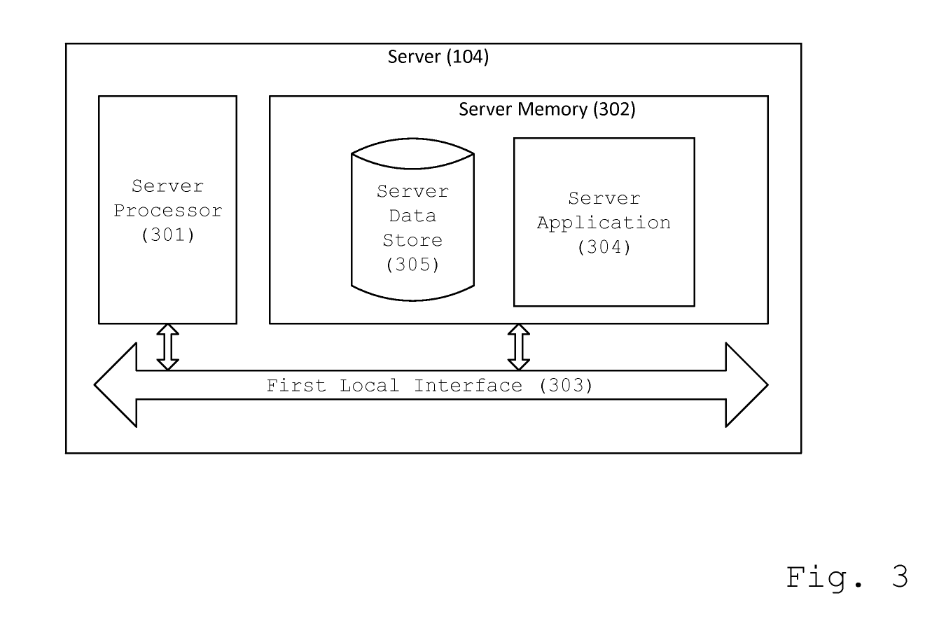

FIG. 2A illustrates an embodiment of reminder device 101. Reminder device 101 can comprise a screen 201. Input devices can include keypad, buttons, track balls, joysticks, or scroll wheels. Keypad can comprise a plurality of physical buttons comprising alphanumeric characters and/or symbols. However, in an embodiment where screen 201 is a touch screen, keypad can be represented virtually on screen 201. Keypad can be used to add an input data 202 in reminder device 101. In an embodiment wherein reminder device 101 can be a touch screen, text, pictures, audio and/or videos can be buttons that, upon being pressed, capture such pressing as input data 202 from screen 201.

In one embodiment, reminder device 101 can also include an optical device 203. Optical device 203 can be a small camera allowing the capture and the storing of still photographs and/or videos. Optical device 203 can capture still and/or moving images as input data 202. As such, reminder device 101 can create input data 202 from optical device 203, and store it into reminder device 101.

An indicator 204 can be utilized to light up or blink to indicate a notification message, a reminder, and an event entry is received. Indicator can be an LED or any other physical, indicating device. Concurrently, a sound notification alert can also play as indicator 204 flickers. In one embodiment, audio file can be a defined alert sound stored in reminder device 101. In another embodiment, audio file can be input data 202 recorded, and sent from reminder device 101 and or electronic device 102.

FIG. 2B illustrates internal hardware of a reminder device 101 comprising a device processor 205, a device memory 206, and a GPS receiver 207. Input data 202 from screen 201 of electronic device 102 can be sent to device processor 205. Captured data or inputted data of from screen 201, optical device 203, keypad, and/or receiver-transmitter captured from reminder device 101 and electronic device 102 can be sent to a device processor 205. In an embodiment wherein reminder device 101 can be used, captured data can include still photographs, video files, and audio files. Device processor 205 can be a device that executes programs stored in device memory 206. Device memory 206 can be a physical device used to store programs and/or data. Processes can include storing input data 202 to device memory 206, verifying input data 202 is valid and conforms to preset standards, or ensuring all required data. Input data 202 created from reminder device 101 and electronic device 102 can be displayed on screen 201 of reminder device 101. GPS receiver 207 determines location of reminder device 101 using methods commonly known in the art.

FIG. 2C illustrates device memory 206 comprising a device application 208 and device data storage 209. Device application 208 can reside and perform logical functions within device memory 206. Device data storage 209 can be a component in device memory 206 that can be used to retain digital data. Further, device processor 205 can perform processes on the data according to a device application 208 stored in device memory 206. Processes can include storing input data 202 in device data storage 209.

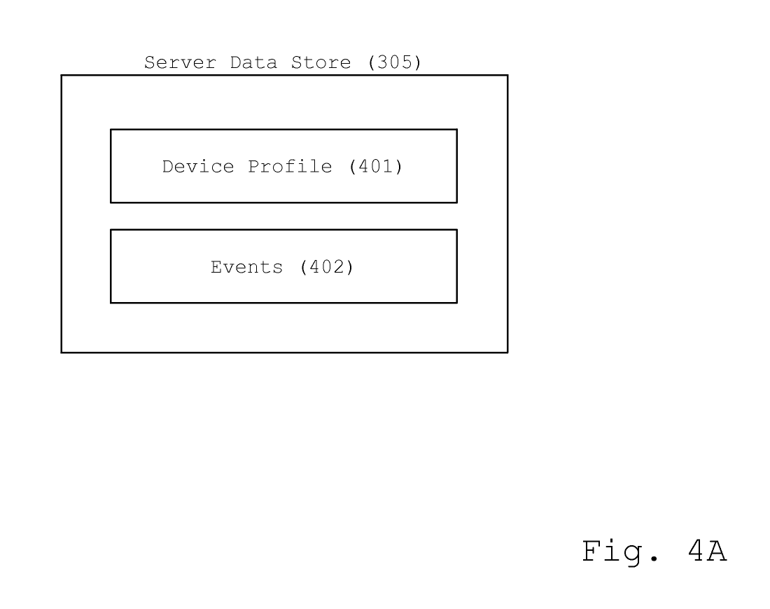

FIG. 3 illustrates a schematic diagram of server 104 according to an embodiment of the present disclosure. Server 104 can comprise a server processor 301, and a first local interface 303. First local interface 303 can be a program that controls a display for the user, which can allow user to view and/or interact with server 104. Server 104 can be a processing unit that performs a set of instructions stored within server memory 302. Server memory 302 can comprise a server application 304, and a server data store 305. Server application 304 can be a program providing logic for server 104. Server data store 305 can be collections of data accessible through server application 304. Further, server application 304 can perform functions such as adding, transferring, and retrieving information on server data store 305 using first local interface 303.

Server 104 includes at least one processor circuit, for example, having server processor 301 and server memory 302, both of which are coupled to first local interface 303. To this end, the server 104 can comprise, for example, at least one server, computer or like device. First local interface 303 can comprise, for example, a data bus with an accompanying address/control bus or other bus structure as can be appreciated.

Both data and several components that are executable by server processor 301 are stored in server memory 302. In particular, server application 304 and, potentially, other applications are stored in the server memory 302 and executable by server processor 301. Also, server data store 305 and other data can be stored in server memory 302. In addition, an operating system can be stored in server memory 302 and executable by server processor 301.

Other applications can be stored in server memory 302 and executable by server processor 301. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in server memory 302 and can be executable by server processor 301. In this respect, the term “executable” can mean a program file that is in a form that can ultimately be run by server processor 301. Examples of executable programs can include a compiled program that can be translated into machine code in a format that can be loaded into a random access portion of server memory 302 and run by server processor 301, source code that can be expressed in proper format such as object code that is capable of being loaded into a random access portion of server memory 302 and executed by server processor 301, or source code that can be interpreted by another executable program to generate instructions in a random access portion of server memory 302 to be executed by server processor 301, etc. An executable program can be stored in any portion or component of server memory 302 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

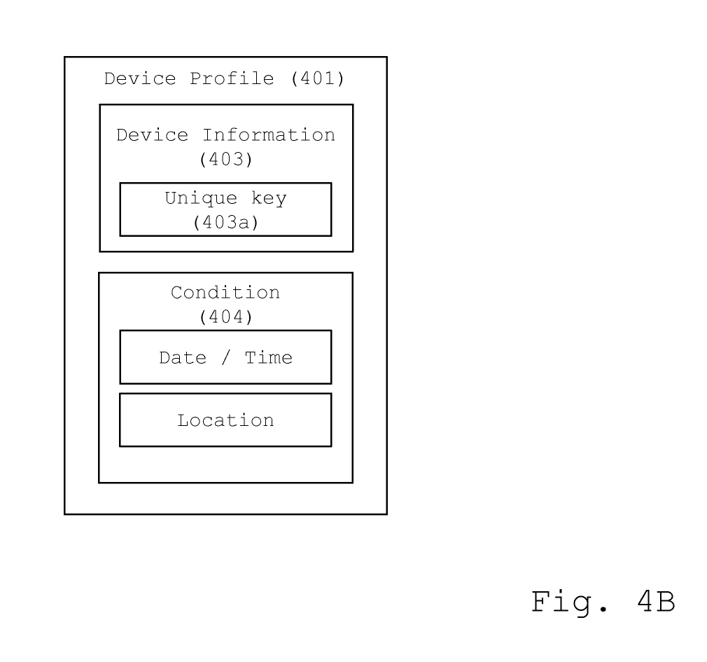

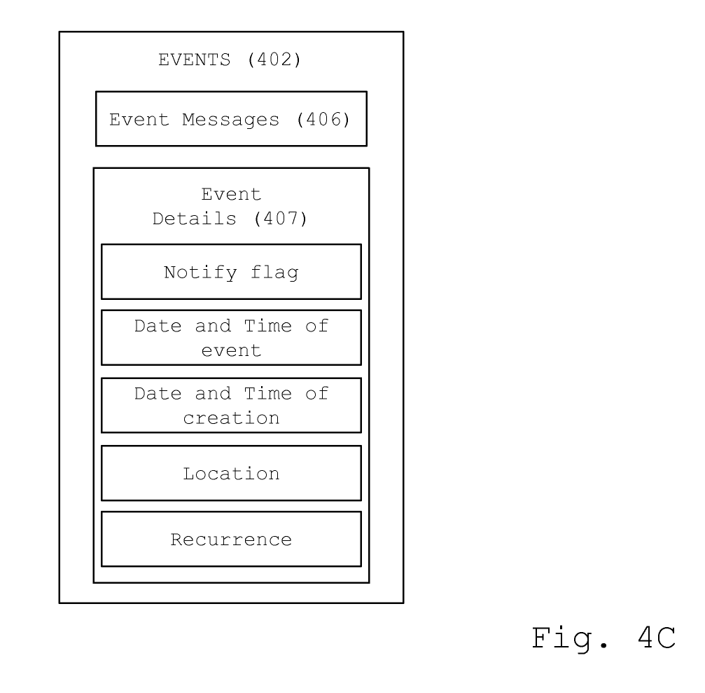

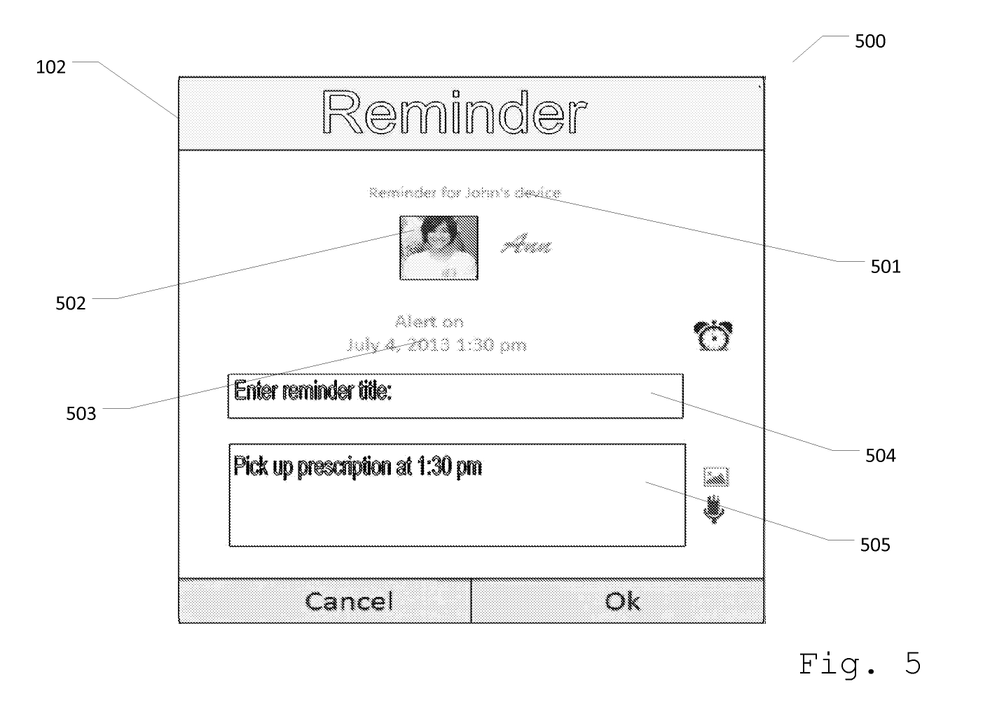

FIG. 4A illustrates a server data store 305 comprising one or more device profiles 401 and one or more events 402. In one embodiment, each reminder device 101 can be related to a unique key such as a serial number. As such, each of device profiles 401, comprising the unique key, can be a retrievable unique account related to reminder device 101. Events 402 can be content information such as text messages, images, and audio files that can be received by reminder device 101 through network 103. In an embodiment, wherein events 402 can be created through reminder device 101, content information can include video files. In one embodiment, device profiles 401 and events 402 can be stored in server 104. In another embodiment, device profile 401 and events 402 can be stored locally or within reminder device 101.

FIG. 4B illustrates device profile 401 comprising device information 403, and a condition 404. Device information 403 can comprise information on reminder device 101 and a device owner such as a name, username, password, email address, contact information, members, and a unique key 403a. While creating a device profile 401, the reminder device 101 can provide device information 403. In one scenario, users other than the device owner can be authorized to create and send event 402 to reminder device 101. In such embodiment, the device owner can add a user as member. The device owner can set up a username and password for each member. As such, an invitation email can be sent to each of the members. The invitation email can contain information that include but are not limited to username, password, and unique key 403a. Therefore, the device owner and his member can share the same unique key 403a.

To access server application 304, the device owner or authorized members can provide account information 403, such as a username, password, and/or unique key 403a. Correct username, password, and unique key 403a can be provided by authorized user to access server application 304.

Condition 404 can be the local time zone applied on reminder device 101. As such, GPS receiver 207 can determine the correct time zone for each reminder device 101. Thus, condition 404 can be populated and updated with date, time, and location every time reminder device 101 connects with server 104.

FIG. 4C illustrates events 402. Events 402 can be the created tasks, notifications, event entry, and/or reminders from authorized users of reminder device 101. Events 402 can contain text, images, audio, and video files. In one embodiment, events 402 can be a notification message or a reminder. In another embodiment, events 402 can be an event entry, wherein any individual from the group can create, post, and store text, images, audio, and video recordings to reminder device 101. Moreover, event entry can comprise a blog that can consist of posts containing a personal encounter, opinions, views, and any collection of information. A blog can be used as a personal diary of an individual. As such, reminder device 101 can be used to collectively store memories, personal views, and special events of a group in a single device.

Each event 402 can comprise an event message 406, and event details 407. Event message 406 can comprise of text, photo, audio, and/or video file. Event details 407 can be the parameters set for each event 402. Event details 407 can include, but are not limited to, information such as notify flag, date and time of event, date and time of creation, location, and recurrence. In one embodiment, a notify flag can distinguish event 402 as a notification event or as an event entry. Therefore, when event 402 is set to notify, event 402 can comprise a reminder that can be triggered when date and time of event, and/or location of event details 407 matches condition 404. When event 402 is not flagged to notify then event 402 can indicate that event 402 can be an event entry. As such, event message 406 can be retrieved and displayed on reminder device 101 according to the date and time of creation. Thus, when event entry's date and time of creation matches with date and time of condition 404, a notification for a new event entry can be displayed on reminder device 101. As an example scenario, event message 406 can have a different date and time of event and date and time of creation. Thus in a case wherein event 402 is an event entry, date and time of event can be used as a reference to the date and time wherein event 402 can be associated. Therefore the date and time of event of an event entry can be the order wherein events 402 are arranged to display on reminder device 101.

Further, authorized users can set a specific date and time when a created event 402 can display or retrieve event message 406, in one embodiment. In another embodiment wherein event 402 is flagged to notify, notification can be location based. In such embodiment, event message 406 can be displayed when reminder device 101 is at a certain location. Further in another embodiment, notifications can be triggered based on date, time, and location. In such embodiment, all parameters must be met or supplied for notifications to be triggered. Further, event 402 can be set to recur. As such, event message 406 can be displayed repeatedly according to a specified recurrence such as daily, weekly, or yearly. Since device information 403 can be required when accessing server application 304, only authorized users can create events 402. Therefore, as a user accesses server application 304, server application 304 can associate each events 402 created with event details 407. This can ensure that each event 402 created by any user is associated to the correct reminder device 101.

For the purpose of this disclosure, date, time, and location discussed herein can be stored within a memory based on Greenwich Meridian Time (GMT). Greenwich Meridian Time (GMT) is the basis of every time zone in the world. Thus, ensuring that events 402 can be triggered at the correct date and time, regardless of the time zones in which events 402 are created.

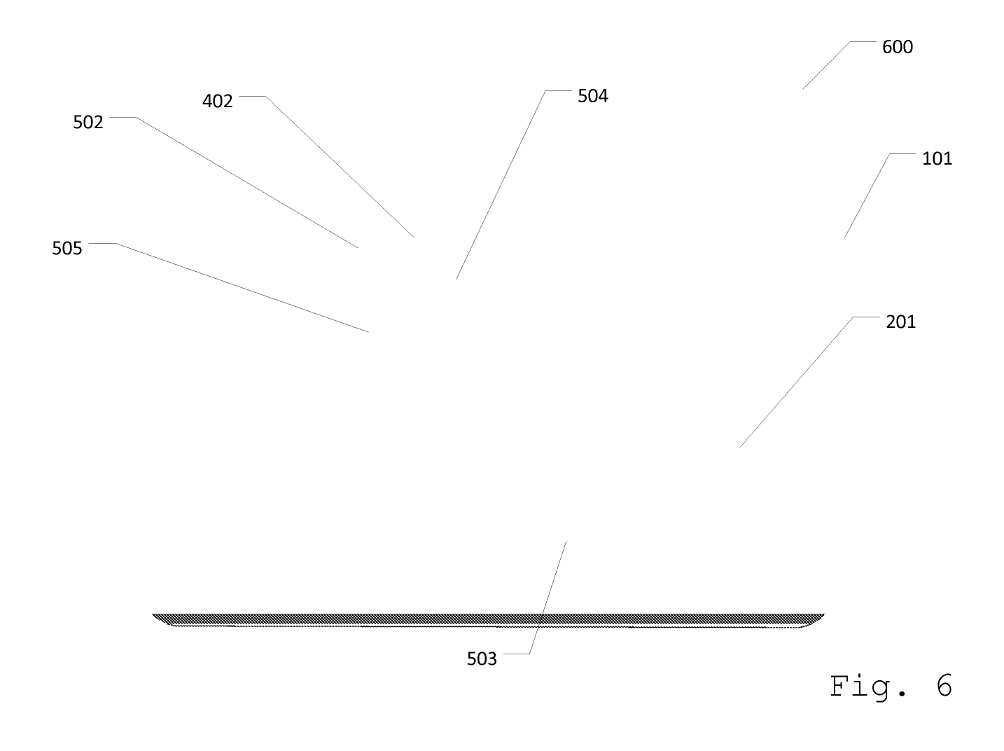

FIG. 5 illustrates screen 201 of electronic device 102 displaying create a reminder page 500. In this embodiment, each reminder created can be associated with each event 402. Reminder page 500 can comprise details such as, a device name 501, a sender 502, an event time 503, an event title 504, and an event body 505. Device name 501 can be a name set by an owner of device reminder 101. Device name 501 can be a family name, a group name, or any name that can identify a specific reminder device 101. Furthermore, device name 501 can be associated with device information 403. Sender 502 can be the name of an authorized member or user of reminder device 101. Sender 502 can be associated with text or image file that can easily identify a member of reminder device 101. Event time 503 can be the date wherein event has or can take place. In an embodiment wherein event 402 can be a notification message, event time 503 can be the date and time of event. As such, event time 503 can be set to alert or notify on reminder device 101 once event time 503 matches the date and time of condition 404. In another embodiment, wherein event 402 can be an event entry, event time 503 can be used to indicate the date of an occasion, event, or memories. As such, event 402 can be stored, arranged, and retrieved according to the date and time set on event time 503. Therefore in this embodiment, event time 503 can be equivalent to date and time of event of event details 407. Event title 504 and event body 505 can be stored as event message 406. Event title 504 can be a brief description of an event entry or notification created. Event body 505 can comprise a complete description and information of an event. Event body 505 can comprise of texts, images, and/or audio files. Once, a user is done filling up required information on reminder page 500, event 402 can be created, sent, and stored in server memory 302.

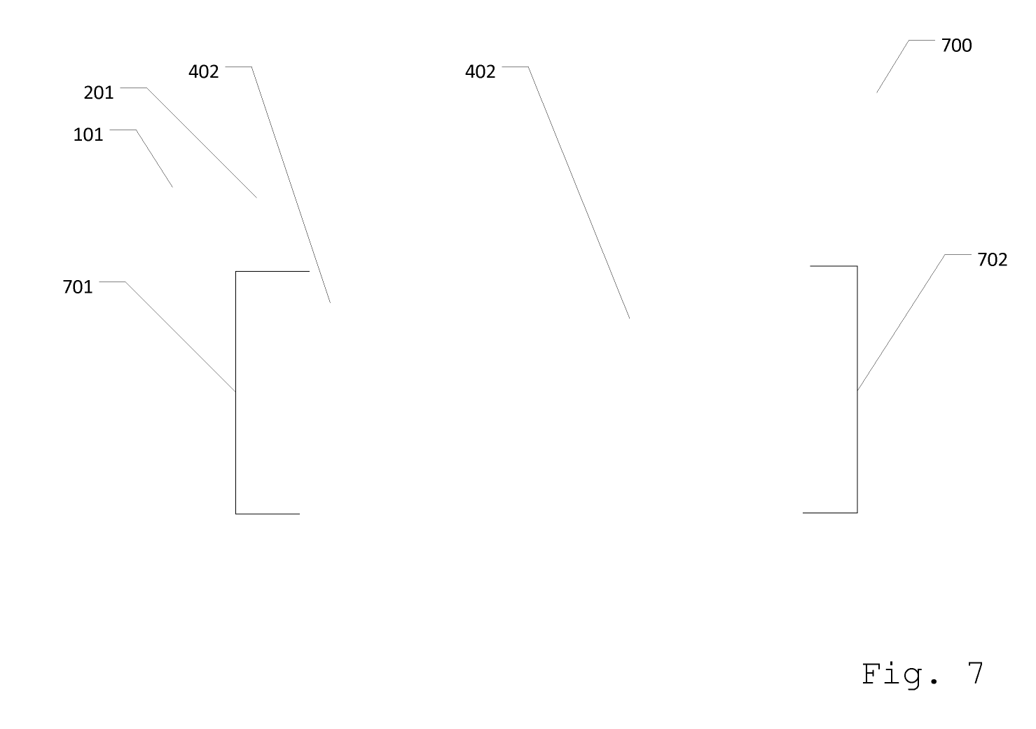

FIG. 6 illustrates screen 201 of reminder device 101 displaying a created event 402, as an event notification page 600. After event 402 is stored in server memory 302, reminder device 101 can communicate with server 104 through network 103. Events 402 associated with reminder device 101 can be retrieved and stored within device memory 206. Thus, when local date and time of reminder device 101 matches with the date and time of event details 407, reminder device 101 triggers a notification page 600 that can display event 402. Notification page 600 can display information such as sender 502, event time 503, event title 504, and event body 505. In one embodiment, when notification page 600 is displayed, main page of reminder device 101 can be disabled at the background.

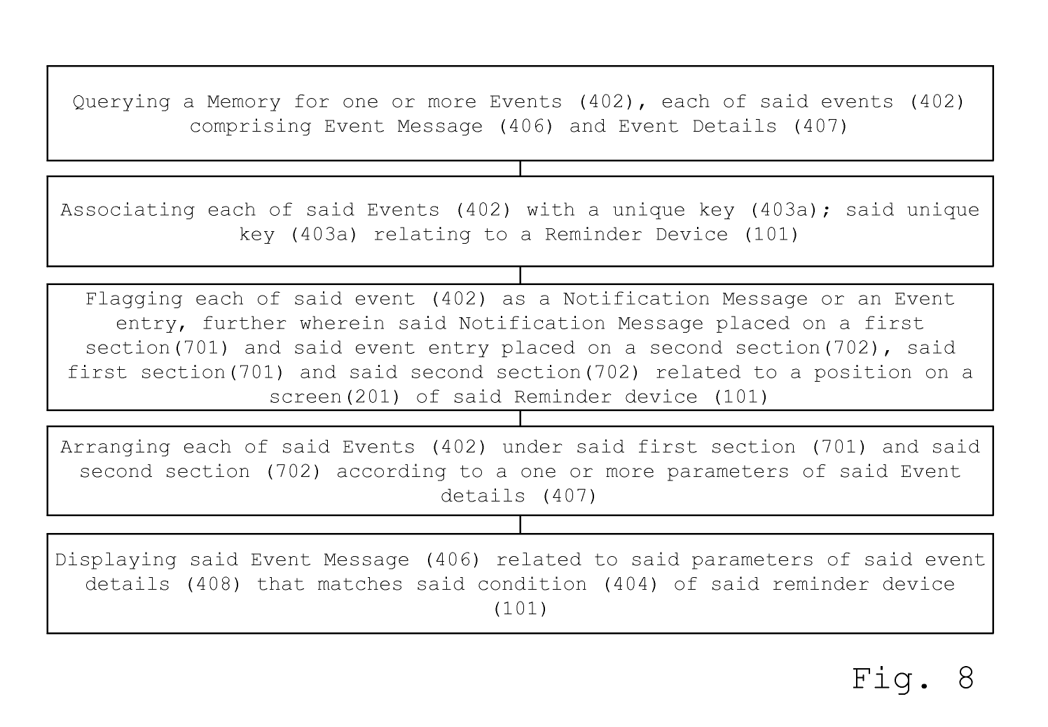

FIG. 7 illustrates screen 201 of reminder device 101 displaying a main page 700. Closing notification page 600 can display main page 700 of reminder device 101. Main page 700 can comprise a first section 701 and a second section 702. In one embodiment, either section can be a blog format. In an embodiment wherein events 402 can be a notification message, event 402 can be displayed as thumbnails under first section 701. In another embodiment wherein events 402 can be an event entry, events 402 can be displayed under second section 702. In these embodiments, events 402 can be collectively displayed at first section 701 and second section 702 according to the date and time of event. Events can be a past or future event.

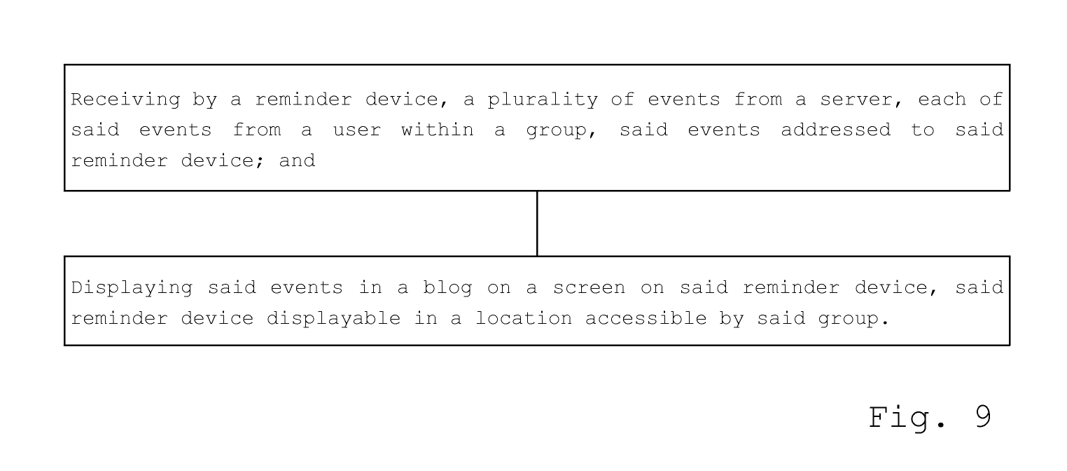

FIG. 8 illustrates an exemplary method for displaying an event on a reminder device 101. A reminder device 101 can query a memory for one or more events 402. In one embodiment, events 402 can be stored in a device memory 206 of reminder device 101. As such, reminder device 101 can query events 402 locally and does not need to connect via network 103 to retrieve events 402 from a server 104. In another embodiment, events 402 can be queried by reminder device 101 from a server memory 302 through network 103. As such, events 402 can be created through electronic device 102 and transferred to server 104 through network 103. Each of said events 402 can be associated with a unique key 403a. Further, unique key 403a can be related to reminder device 101. As such, events 402 associated with unique key 403a can be filtered and stored within device memory 206 of reminder device 101 that matches unique key 403a.

During the creation of a reminder or an event, events 402 can be flagged as a notification message or an event entry. As such, events 402 can be associated to one or more parameters of event details 407. Flags of events 402 can also be related to a position on screen 201 of reminder device 101. Events 402 that can be flagged as a notification message can be placed on a first section 701 of screen 201. Furthermore, events 402 flagged as an event entry can be placed on a second section 702 of screen 201. Moreover events 402 placed on first section 701 and second section 702 can be both arranged according to the date and time of event parameter of event details 407. In an embodiment wherein event 402 can be a notification message, when condition 404 matches date and time of event, and/or location parameters of event details 407, event message 406 can be displayed as a notification reminder. Further when event 402 can be an event entry, a notification can be triggered on reminder device 101 once condition 404 matches date and time of creation parameter of event details 407. As such event message 406 can be displayed on reminder device 101 and any member of the group can be informed that a new event entry is received. In these embodiments, when notification is received on reminder device 101 the display of event message 406 can also trigger a sound notification alert or a blinking Indicator 204. Moreover in these embodiments, event message 406 displayed on reminder device 101 can be in text, photo, video, or audio in form.

FIG. 9 illustrates a second embodiment of a preferred method. One method comprises receiving, by reminder device 101, a plurality of events 402 from server 104. Each of events 402 can be from a user within a group, and events 402 can be addressed to reminder device. The method can also comprise the step of displaying events 402 in a blog on a screen on reminder device 101. Reminder device 101 can be displayable in a location accessible by the group.

Server memory 302 can include both volatile and nonvolatile memory and data storage components. Volatile components do not retain data values upon loss of power. Nonvolatile components, on the other hand, retain data upon a loss of power. Thus, server memory 302 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, server processor 301 can represent multiple server processors 301. Likewise, server memory 302 can represent multiple server memories 302 that operate in parallel processing circuits, respectively. In such a case, first local interface 303 can be an appropriate network, including network 103 that facilitates communication between any two of the multiple server processors 301, between any server processor 301 and any of the server memory 302, or between any two of the server memory 302, etc. First local interface 303 can comprise additional systems designed to coordinate this communication, including, but not limited to, performing load balancing. Server processor 301 can be of electrical or of some other available construction.

Although server application 304, and other various systems described herein can be embodied in software or code executed by general purpose hardware discussed above, server application 304 can also be embodied in dedicated hardware or a combination of software/general purpose hardware and dedicated hardware. If embodied in dedicated hardware, each server application 304 can be implemented as a circuit or state machine that employs a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 8 shows the functionality and operation of an implementation of portions of server application 304. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as server processor 301 in a computer system or other system. The machine code can be converted from the source code, etc. If embodied in hardware, each block can represent a circuit or a number of interconnected circuits to implement the specified logical function(s).

Although the flowchart of FIG. 8 shows a specific order of execution, the order of execution can differ from what is depicted. For example, the order of execution of two or more blocks can be rearranged relative to the order shown. Also, two or more blocks shown in succession in FIG. 8 can be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. All such variations are within the scope of the present disclosure.

Also, any logic or application described herein that comprises software or code, including server application 304, can be embodied in any computer-readable storage medium for use by or in connection with an instruction execution system such as, server processor 301 in a computer system or other system. The logic can comprise statements including instructions and declarations that can be fetched from the computer-readable storage medium and executed by the instruction execution system.

In the context of the present disclosure, a “computer-readable storage medium” can be any medium that can contain, store, or maintain the logic or application described herein for use by or in connection with the instruction execution system. The computer-readable storage medium can comprise any one of many non-transitory physical media, such as electronic, magnetic, optical, electromagnetic, infrared, or semiconductor media. More specific examples of a suitable computer-readable storage medium can include, but are not limited to, magnetic tapes, magnetic floppy diskettes, magnetic hard drives, memory cards, solid-state drives, USB flash drives, or optical discs. Also, the computer-readable storage medium can be a random access memory (RAM), including static random access memory (SRAM), dynamic random access memory (DRAM) or magnetic random access memory (MRAM). In addition, the computer-readable storage medium can be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for displaying collective events for a group comprising
receiving by a reminder device, a plurality of events from a server, each of said events from a user within a group, said events addressed to said reminder device; and
displaying said events in a blog on a screen on said reminder device, said reminder device displayable in a location accessible by said group.

2. The method of claim 1 wherein said events are transmitted to said server by a plurality of electronic devices, each of said electronic devices associated with one of said users.

3. The method of claim 2 wherein said notifications are transmitted only upon a condition being satisfied.

4. The method of claim 3 wherein said condition is a proximity threshold between said electronic device related to said event, and said reminder device, measurable by one or more GPS locators.

5. The method of claim 3 wherein said condition relates to a date and time.

7. The method of claim 1 further comprising the step scrolling alert text upon receiving one of said events.

8. The method of claim 1 wherein said event comprises a text file.

9. The method of claim 1 wherein said event comprises an image file.

10. The method of claim 1 wherein said event comprises a video file.

11. The method of claim 1 wherein said event comprises an audio file.

12. A reminder device comprising
a screen;
a processor; and
a memory comprising an application, said application programmed to receive a plurality of events from a server, each of said events from a user within a group, said events addressed to said reminder device; and display said events in a blog on said screen on said reminder device, said reminder device displayable in a location accessible by said group.

13. The reminder device of claim 12 further comprising a GPS system.

14. The reminder device of claim 12 wherein said application displays said events within said blog in order based on time of said events.

15. The reminder device of claim 12 wherein said events within said blog comprising past events and future events.

16. The reminder device of claim 12 wherein a first portion of said screen displays past events, and a second portion of said screen displays future events.

17. The reminder device of claim 12 wherein a first portion of said screen displays events, and a second portion of said screen displays notifications.

18. A computer readable storage medium having a computer readable program code embodied therein, wherein the computer readable program code is adapted to be executed to implement the method of claim 1.
